(19) United States
(12) Patent Application Publication
(10) Pub. No.: US 2026/0312982 A1
(43) Pub. Date: Oct. 8, 2026

(54) METHODS AND SYSTEMS FOR NETWORK VULNERABILITY EVALUATION AND MITIGATION

(71) Applicant: T-Mobile Innovations LLC, Overland Park, KS (US)

(72) Inventors: Scott BAXTER, Leonard, TX (US); Gyani PILLALA, Frisco, TX (US)

(21) Appl. No.: 19/171,187

(22) Filed: Apr. 4, 2025

(51) Int. Cl. H04L 9/40

(52) U.S. Cl. CPC H04L 63/1433; H04L 63/1441

(57) ABSTRACT

A method comprising training one or more applications executing at a data model system using historical data describing prior detected vulnerabilities across the communication network, determining, by the application using the one or more applications executing at the data model system, a vulnerability associated with a software asset in the communication network, a network impact of the vulnerability across different elements of the communication network, and a mitigation action for each of the different elements to mitigate the vulnerability associated with the software asset across the different elements, initiating, by the application, automation of the mitigation action at the software asset and at each of the different elements to mitigate the vulnerability associated with the software asset in the communication network.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Platforms where software applications can be deployed refer to underlying infrastructure or orchestration systems, such as cloud services or container orchestration systems, that provide computational resources and runtime environments for software operation. These platforms may be responsible for managing the execution of software applications, including provisioning, scaling, and networking. Environments may be logical configurations or operational stages within the software development lifecycle, such as development, testing, staging, or production, where software applications are deployed for specific purposes. Weaknesses may exist at the platform level, such as insecure configurations, unpatched vulnerabilities, or insufficient access control, and at the environment level, such as improper isolation between environments, usage of sensitive data in non-production environments, or incomplete testing of security controls prior to production deployment.

### SUMMARY

In an embodiment, a method for vulnerability evaluation and mitigation in a communication network is disclosed. The method comprises maintaining, by an application executing at a database system, historical data describing prior detected vulnerabilities across the communication network, in which the historical data comprises historical ownership data, historical deployment data, and historical environment data associated with each of the prior detected vulnerabilities, and training, by the application, a data model system to identify a vulnerability associated with a software asset in the communication network, determine a network impact of the vulnerability in the communication network, and a mitigation action for the vulnerability. The method further comprises forwarding, by the application, current network and software asset data to the data model system, identifying, by the application using a vulnerability application executing at the data model system, the vulnerability at the software asset in the communication network, determining, by the application using a network impact application executing at the data model system, the network impact of the vulnerability across different elements in the communication network, determining, by the application using a mitigation application executing at the data model system, a mitigation action for each of the different elements to reduce or eliminate a risk of the vulnerability associated at the software asset and at the different elements, and initiating, by the application, the mitigation action at the software asset and each of the different elements. The vulnerability is at least one of a defect, a weakness, or a misconfiguration in the software asset that, when exploited, is likely to comprise at least one of an integrity, an availability, a confidentiality, or a functionality of the software asset or the communication network. The different elements are located in at least one of a platform, an environment, or an interconnected system associated with the software asset. The mitigation action comprises at least one of patching, reconfiguring, isolating, or restricting access to the software asset or each of the different elements.

In another embodiment, a system comprising a non-transitory memory, a processor communicatively coupled to the memory, and an application stored at the memory is disclosed. The non-transitory memory is configured to store historical data describing prior detected vulnerabilities across a communication network, wherein the historical data comprises historical ownership data, historical deployment data, historical environment data, historical network impact data, and historical mitigation data associated with each of the prior detected vulnerabilities. The application, when executed by the processor, causes the processor to be configured to train a data model system using the historical data to identify a vulnerability associated with a software asset in the communication network, determine a network impact of the vulnerability in the communication network, and a mitigation action for the vulnerability, identify, using a vulnerability application executing at the data model system, the vulnerability at the software asset in the communication network, determine, using a network impact application executing at the data model system, a network impact of the vulnerability across different elements in the communication network, and determine, using a mitigation application executing at the data model system, a mitigation action to perform at the software asset and at each of the different elements to reduce or eliminate a risk of the vulnerability associated with the software asset at the software asset and at each of the different elements. The different elements are located in at least one of a platform, an environment, or an interconnected system associated with the software asset. The mitigation action comprises at least one of patching, reconfiguring, isolating, or restricting access to at least one of the software asset or the different elements.

In yet another embodiment, a method comprises training one or more applications executing at a data model system using historical data describing prior detected vulnerabilities across the communication network, determining, by the application using the one or more applications executing at the data model system, a vulnerability associated with a software asset in the communication network, a network impact of the vulnerability across different elements of the communication network, and a mitigation action for each of the different elements to mitigate the vulnerability associated with the software asset across the different elements, initiating, by the application, automation of the mitigation action at the software asset and at each of the different elements to mitigate the vulnerability associated with the software asset in the communication network.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network for vulnerability evaluation and mitigation according to an embodiment of the disclosure.

FIG. 2 is a diagram illustrating the training of a data model system in the communication network of FIG. 1 according to various embodiments of the disclosure.

FIG. 3 is a diagram illustrating the use of the different applications in the data model system to perform network vulnerability evaluation and mitigation in the communication network of FIG. 1 according to various embodiments of the disclosure.

FIG. 4 is a flowchart of a first method of network vulnerability evaluation and mitigation according to various embodiments of the disclosure.

FIG. 5 is a flowchart of a second method of network vulnerability evaluation and mitigation according to various embodiments of the disclosure.

FIG. 6 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Software vulnerabilities are weaknesses in a program that, when exploited, are likely to compromise the security, integrity, availability, or functionality of a software asset. Exploitation of a vulnerability refers to the process by which an attacker leverages a vulnerability to actually compromise the integrity, confidentiality, availability, or functionality of the software. In a telecommunications network environment, software assets may be deployed across multiple platforms (e.g., cloud computing services, containerized environments, or on-premises infrastructure) and exist in different environments (e.g., development, integration, testing, staging, and production) to support various applications and network operations. Software assets may include applications, libraries, frameworks, programming languages, application programming interfaces (APIs), or other elements that are utilized in the operation and deployment of software systems. A vulnerability identified in a software asset may have a network-wide impact, as the affected asset may be used in multiple locations, environments, or interconnected systems, increasing the risk of security breaches, service disruptions, or unauthorized access. Moreover, dependencies between software assets—such as core network components, subscriber management services, or third-party integrations—may cause vulnerabilities to propagate across the network, further amplifying the potential attack surface and making mitigation more complex.

When a vulnerability is identified, owners or developers of affected software assets may receive a notification about the issue, often with recommendations for a patch or update. However, these approaches lack network-wide visibility into where and how the vulnerable software asset is deployed across different platforms and environments. When a vulnerability is identified in a software asset, systems may not dynamically correlate the affected asset with its various deployment instances across different platforms and environments, nor do they evaluate how the vulnerability may propagate through interconnected systems. This results in a fragmented understanding of the security risk, where mitigation actions may be applied inconsistently or fail to account for dependencies between software assets. As a result, service providers may face challenges determining the operational significance of a vulnerability, thereby limiting the ability of service providers to enforce security policies uniformly across all affected deployments, or proactively prevent further exploitability in interconnected network systems. Ultimately, the lack of a network-wide understanding of vulnerabilities leads to more failures and disruptions in the network, thereby consuming more networking and processing resources, and significantly degrading customer service.

The present disclosure addresses the foregoing technical problems by providing a technical solution in the technical field of network security and vulnerability management. In various embodiments, vulnerabilities at assets (hardware or software assets) may be identified throughout a network, a network impact of each vulnerability may be identified based on various policies, and an optimal mitigation action may be determined and implemented to eliminate or reduce the risk posed by each vulnerability across all the impacted elements in the network. The disclosed solution thus enables network-aware vulnerability assessment, allowing for the identification, tracking, and mitigation of vulnerabilities across multiple platforms, environments, and ownership teams in the communication network. By leveraging a data model system implementing a machine learning model, the methods and systems disclosed herein improve the accuracy of vulnerability impact assessments to ensure that mitigation actions are applied efficiently and consistently across all affected systems. As a result, the embodiments disclosed herein minimizes security risks, reduces service disruptions and network crashes, and improves the overall resilience and capacity of the communications network and, for example, the telecommunications infrastructure.

A communication network used for vulnerability evaluation and mitigation may include one or more software or hardware assets at which vulnerabilities may occur, a database system executing an application for vulnerability evaluation and network impact and mitigation determination, a data model system implementing a machine learning model used by the application, one or more data stores storing data used by the database system and the data model system, one or more environments, one or more platforms, and one or more external systems. A vulnerability may refer to at least one of a defect, a weakness, or a misconfiguration in an asset that, when exploited, is likely to compromise at least one of an integrity, an availability, a confidentiality, or a functionality of the asset or the communication network.

An asset may refer to any software or hardware element in the communication network. While a software asset is described in the examples provided herein, it should be appreciated that the embodiments disclosed herein may apply to hardware assets as well. A software asset may refer to, for example, at least one of an application, a library, a framework, an API, a dataset, a programming language, or any other software artifact in the communication network. A hardware asset refers to any physical computing, networking, or telecommunications equipment that is deployed within a communications network. An environment may refer to a logically defined operational context in which a software asset is deployed, configured, and executed for a specific stage in the software lifecycle, including development, integration, testing, staging, or production. A platform may refer to the underlying infrastructure, computing environment, or orchestration system that provides the necessary resources for deploying, managing, and operating software assets. For example, platforms may include cloud computing services, container orchestration frameworks, virtualization environments, bare-metal infrastructures, on-premise infrastructures, etc.

The one or more data stores may maintain data collected over time describing a history of vulnerabilities experienced at the communications network. For example, the data stores may store historical data describing vulnerabilities that were previously detected at the network and sometimes even exploited. The historical data may also indicate different impacted elements in the communications network that were also affected by a prior detected vulnerability (other than the asset at which the prior vulnerability was detected). The impacted elements in the communication network may refer to any software, hardware, service, or operational component that interacts with or depends on the asset that has the vulnerability. For example, the impacted elements may include network infrastructure components, software-defined components, external integrations, etc. In an embodiment, the historical data may store historical ownership data, historical deployment data, historical environment data, historical vulnerability data, historical network impact data, and historical mitigation data, each collected over an extended period of time in the past and pertaining to one or more prior detected vulnerabilities. The data stores may also store current network and asset data. The current network and asset data may include current, up-to-date ownership data, deployment data, and infrastructure data across various assets and elements in the communication network. The current network and asset data may be data collected over a more recent predefined period of time (e.g., the past X number of days, the past 3 months, etc.).

The database system may include an application that may communicate with the data stores and use the data model system to evaluate vulnerabilities across the communication network and determine mitigation actions to address the vulnerabilities. The database system may also include a data store storing various policies that include logic, code, and/or rules for using the data model system to perform tasks in relation to evaluating vulnerabilities and determining mitigation actions to address the vulnerabilities. The policies may include, for example, a vulnerability policy, a network impact policy, and a mitigation policy, as further described below.

The data model system may be a collection of one or more servers or computer systems communicatively coupled to the service system. The data model system may be a computational system (e.g., including both software and hardware components) designed to make predictions or forecasts based on patterns learned from the aforementioned historical data and other data provided as input into the data model system. As further described herein, the data model system may run one or more machine learning models (with corresponding algorithms, parameters, and weights) to predict the presence of vulnerabilities at assets in the communication network, determine a network impact of the vulnerabilities, and determine mitigation actions to address the vulnerabilities. The data model system may include various applications, each running respective algorithms, parameters, and weights, and each being tailored to output predefined types of data based on the input data of the respective application. For example, the data model system may include a vulnerability application, a network impact application, and a mitigation application. Each of the applications may be respectively trained based on the aforementioned historical data stored at the data stores, the associated policy, and additional feedback data received from the database system.

To train the applications at the data model system, the application at the database system may collect the historical data describing numerous vulnerability incidents (e.g., in the hundreds, thousands, or millions) detected throughout the communication network from the data stores. The application may then provide this data as input training data to train the vulnerability application, network impact application, and mitigation application executing at the data model system. This training data may be provided to the applications as labelled datasets or unlabeled datasets. As such, multiple layers of labeled and/or unlabeled data (e.g., the historical data and the policies), and an enormous amount of this data, are being used to train the machine learning models at the data model system to detect and resolve vulnerabilities at the communication network.

The application at the database system may also provide one or more vulnerability policies to the vulnerability application at the data model system to program the algorithms of the vulnerability application according to the vulnerability policies. The vulnerability policy may include logic or code defining one or more conditions, which when satisfied, may instruct the application (e.g., using the vulnerability application) to detect one or more vulnerabilities at an asset and determine a type of vulnerability at the asset, for example, based on the historical vulnerability data describing similar assets having experienced similar vulnerabilities in the past. For example, a vulnerability policy may indicate that when an application exhibits abnormal runtime behavior (e.g., unexpected resource consumption, unusual API calls, or unauthorized system modifications), then the software asset may be tagged as vulnerable under a vulnerability category (e.g., runtime category). As another example, a vulnerability policy may indicate that when an incompatibility is detected in a software programming language, then all software assets coded using the software programming language may be tagged as vulnerable under a vulnerability category (e.g., associated with the programming language). In this way, the vulnerability application may be used to detect the vulnerability and categorize the vulnerability (i.e., the vulnerability application may output an identifier/name of the vulnerability, an identifier/location of the vulnerable software asset, and category of the vulnerability).

The application may also provide one or more network impact policies to the network impact application at the data model system to program the algorithms of the network impact application according to the network impact policies. The network impact policy may include logic or code defining one or more conditions, which when satisfied, may instruct the application (e.g., using the network impact application) to determine the network impact of a particular vulnerability, for example, based on historical data describing the network impact of similar vulnerabilities detected at similar types of assets. The network impact may indicate the elements in the communication network that may be likely to be impacted or affected by the vulnerability at the asset, if exploited (e.g., likelihood may be based on a value or confidence score of the predicted impact at the element being above a threshold score). The network impact may be formatted as a report, which may identify each of the impacted elements in the communication network, a description of the predicted impact and an indication of the severity of the risk at the element if the vulnerability is exploited (e.g., based on the historical data describing similar vulnerabilities). The network impact may also be defined as a score, computed using the algorithms and parameters at the network impact application based on the historical data, defining a level of severity of the network impact (e.g., a higher score may indicate a higher severity level, and thus a higher urgency to mitigate- or vice versa). In this way, the network impact application may be used to determine and quantify a network impact of a detected vulnerability in the network (i.e., the network impact application may output a network impact score and/or a network impact report for the asset and/or each impact element).

In some cases, the identified vulnerabilities and network impact (e.g., the score/report) may be embodied as one or more knowledge graphs. A knowledge graph is a structured representation of information where entities (e.g., elements, or elements having the identified vulnerabilities) are nodes, and the relationships between the entities (such as “connected to,” “has vulnerability,” or “impacts”) are edges between the nodes. This graph-based model may enable intuitive, interconnected views of the external system, making it easier to understand how the different components relate and interact. To depict vulnerabilities and the associated network impact using a knowledge graph, each asset may be a node with associated properties, and/or each vulnerability can also be a node, linked to the affected assets through relationships (e.g., hasVulnerability). Metadata, such as identifiers, network impact scores, remediation statuses, etc., may be attached to each node as attributes. The network impact of a vulnerability may be modeled through relationships (e.g., impacts and/or propagatesTo), connecting a vulnerability to other nodes that may be indirectly affected-such as dependent services, connected hosts, or user-facing applications. The knowledge graph may clearly reveal not only which assets are vulnerable, but also which parts of the network might be disrupted if the vulnerability is exploited.

By expressing this data in a knowledge graph, richer queries and automated reasoning may be enabled, which may be particularly useful for risk prioritization. For example, knowledge graphs my highlight vulnerabilities with widespread or high-consequence network impacts (e.g., more sever network impacts that are customer facing). Knowledge graphs may also help teams move from isolated vulnerability management to impact-aware mitigation strategies for vulnerabilities, ideally before the vulnerabilities are exploited. The knowledge graphs therefore support better automated decision making (for mitigation actions, as further described below) and a more resilient network posture.

The application may also provide one or more mitigation action policies to the mitigation application at the data model system to program the algorithms of the mitigation application according to the mitigation action policies, the determined network impact, and/or the category of the vulnerability. The mitigation action policy may include logic or code defining one or more conditions, which when satisfied, may instruct the application (e.g., using the mitigation action application) to determine a mitigation action either only the asset with the vulnerability and/or at all the elements impacted by the vulnerability. The mitigation action may involve, for example, patching, reconfiguring, isolating, updating, resetting, throttling, or restricting access to the asset and/or to each of the elements.

For example, a mitigation action policy may instruct one or more predefined mitigation actions to be performed when the vulnerability is of a certain category or the asset is a particular type of asset. Additionally or alternatively, the mitigation action may be determined to be optimal based on the historical mitigation action data describing that similar mitigation actions have had a higher than threshold percent success rate in reducing or eliminating the risk of the vulnerability. In this way, the mitigation application may be used to determine one or more mitigation actions to attempt to remediate the vulnerability at the software asset and/or at each of the impacted elements in the communication network (i.e., the mitigation application may output mitigation data describing the determined mitigation actions).

Therefore, each of the applications at the data model system may be programmed with policies that may be trained using the vast amount of historical data collected over time to identify patterns and terms and select the appropriate machine learning algorithm for each context or use case based on the input source data (current network and asset data). For example, during training, the algorithms at the data model system may update the parameters and weights through processes such as gradient descent, adjusting weights and biases based on the input training data to minimize errors in the predictions. The data model system may then be used to detect vulnerabilities in the communication network, determine the network impact of the vulnerabilities, and suggest optimal mitigation actions to resolve (or attempt to resolve) the vulnerabilities across all impacted elements.

Once the machine learning algorithms and applications at the data model system have been trained, the application executing at the database system may continuously or intermittently (e.g., based on a predefined schedule) input current network and asset data into the data model system. The current network and asset data may include the most recently collected ownership data describing the ownership of currently used/deployed assets, deployment data describing platforms at which assets are deployed or used, environment data describing environments in which assets are running or tagged, and/or vulnerability data describing publicly known software vulnerabilities received from external sources.

As an example, suppose a programming language is used by various teams in a business enterprise across various software assets, deployed across various platforms, and running in various environments in the software development lifecycle. The current network and asset data may include the ownership data describing the teams in the business enterprise coding with the programming language, deployment data describing the platforms in which the programming language is used, and environment data describing environments in which which the programming language is running. The application at the database system may provide the current network and asset data as input into the data model system.

The application at the database system may use the vulnerability application and a vulnerability policy to determine that the programming language is vulnerable, and assign a vulnerability identifier to the programming language. The application may also use the vulnerability application to determine a category of the vulnerability based on a vulnerability policy, for example, including conditions associated with the nature and exploitability of the vulnerability. For example, the category may be based on the determined vulnerability, the types of applications and services coded using the programming language, the severity of the risk of the programming language vulnerability, etc. As a first a second example, the category may indicate a code-based vulnerability, a configuration-based vulnerability, a dependency and supply chain vulnerability, network-based vulnerability, authentication and authorization vulnerability, insider threat vulnerability, zero-day vulnerability, etc. As a second example, the category may indicate a severity level of the vulnerability (low, medium, high, critical, etc.).

Once the vulnerability and category are identified, the application at the database system may use the network impact application to determine a network impact (or network impact data) of the vulnerability using a network impact policy. The network impact data may identify all impacted elements that may be affected if the vulnerability at the asset is exploited, and may indicate an extent or severity of the impact at the elements. The application may generate the network impact data in the form of a network impact report for the asset and/or one or more of the impacted elements, and/or a network impact score indicating a severity or breadth of the risk at the asset itself and/or at each of the impacted elements if exploited.

The application may then use the mitigation application at the database system to determine one or more mitigation actions to perform at the asset and/or one or more of the impacted elements to eliminate or reduce the risk of the vulnerability if exploited. The one or more mitigation actions may be determined based on the mitigation action policy, which may include conditions based on, for example, the network impact data, the category of the vulnerability, and/or one or more mitigation action policies.

For example, the mitigation action may be to upgrade the programming language to one without a vulnerability, at the platforms and across the environments in which the programming language is running. In some cases, depending on application dependencies, this may involve upgrading other applications and programs prior to upgrading the programming language, to ensure that all application dependencies remain compatible and consistent. The application may use the mitigation application and the mitigation action policies to determine the optimal mitigation actions based on the application dependencies, the category of the vulnerability, and/or the network impact data. The application may then instruct the mitigation action to be performed either at the asset alone, and/or across all the elements impacted by the vulnerability. It should be appreciated that the mitigation action may be different at the asset and each one of the elements based on the severity of the impact and/or the application dependencies, or the mitigation action may be the same at the asset and each one of the elements.

In this way, embodiments disclosed herein help prevent vulnerability related disruptions or network failures from occurring in the communication network by addressing vulnerabilities at all potential locations in the communication network in an intelligent, prioritized manner. Therefore, it follows that network capacity and network resource availability may also be significantly increased due to the reduction in network disruptions and failures.

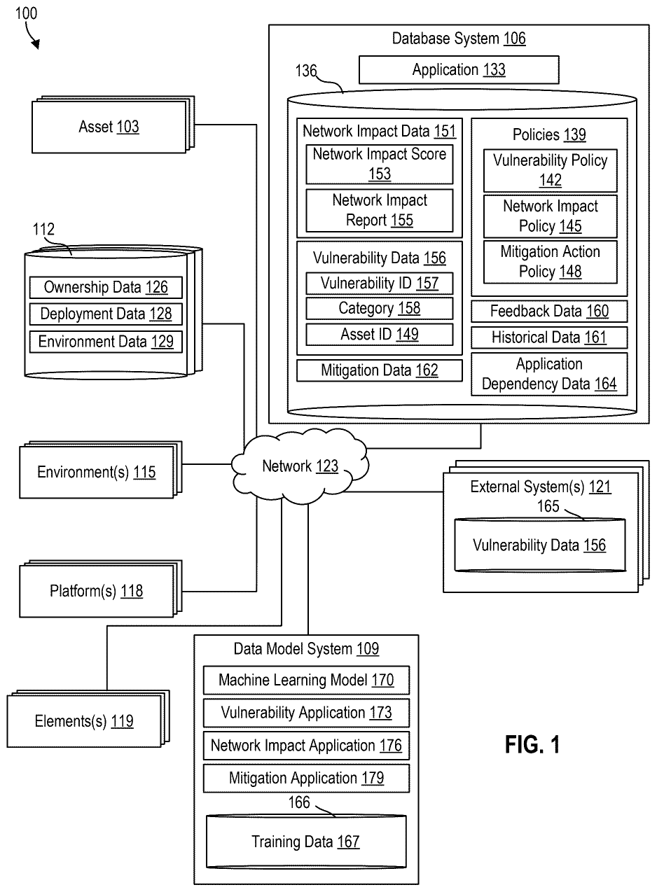

Turning now to FIG. 1, a communication network 100 is described. The communication network 100 includes an asset 103, a database system 106, a data model system 109, one or more data stores 112, one or more environments 115, one or more platforms 118, one or more elements 119, one or more external systems 121, and a network 123. The network 123 may be one or more private networks, one or more public networks, or a combination thereof. While the asset 103, database system 106, data model system 109, data stores 112, environments 115, platforms 118, elements 119, and external systems are shown as separate from the network 123 in FIG. 1, it should be appreciated that one or more of the software asset 103, database system 106, data model system 109, data stores 112, environments 115, platforms 118, elements 119 may be included as part of the network 123 in various embodiments.

The asset 103 may refer to any software or hardware component within the communication network 100 (e.g., a telecommunications network) that can experience a vulnerability, be impacted by a security risk, or influence the operational stability of the communication network 100. Assets 103 may include, for example, software-based components such as applications, virtual network functions (VNFs), APIs, middleware, programming languages, libraries, datasets, runtime environments, and third-party dependencies, as well as hardware-based components such as network switches, routers, base stations, computing infrastructure, and subscriber devices.

An element 119 may refer to any software, hardware, service, or operational component within the communications network 100 that interacts with, depends on, or may be affected by an asset 103. For example, an element 119 may include software-based components (e.g., applications, APIs, virtual network functions, middleware services, etc.), hardware-based components (e.g., network switches, routers, base stations, computing infrastructure, etc.), security enforcement mechanisms (e.g., firewalls, access control systems, intrusion detection systems, etc.), data management systems (e.g., databases, logging frameworks, analytics platforms), external integrations (e.g., third-party APIs, partner network services, Internet of Things (IoT) devices), etc. A vulnerability in an asset 103 may impact one or more elements 119 by introducing security risks, service disruptions, performance degradation, or unintended system behaviors, affecting the integrity, availability, or confidentiality of network operations.

An environment 115 may refer to a logically defined operational context in which a software asset 103 is deployed, configured, and executed for a specific stage in the software lifecycle, including development, integrating, testing, staging, or production. Each environment 115 may be tailored with distinct configurations, data sets, access controls, and security policies to support its intended function, such as feature development, integration validation, pre-production testing, or live user operations. A software asset 103 may exist in multiple environments simultaneously, and vulnerabilities present in one environment may propagate to others if not properly isolated. Misconfigurations, improper access controls, or inadequate security testing in a given environment 115 may result in unauthorized access, data exposure, or disruptions in operational systems. In this way, an environment 115 may be a logically defined operational stage in which a software asset 103 is deployed and executed, including development, testing, staging, or production environments 115.

A platform 118 may refer to the underlying infrastructure, infrastructure, computing environment, or orchestration system that provides the necessary resources for deploying, managing, and operating software assets 103. Platforms 118 may include cloud computing services, container orchestration frameworks, virtualization environments, bare-metal infrastructures, on-premise infrastructures, etc. These platforms 118 may facilitate workload execution, resource allocation, networking, and security policies while enabling software assets 103 to function within a managed environment. Vulnerabilities at the platform level, such as insecure configurations, privilege mismanagement, or unpatched system components, may expose software assets 103 to security threats, unauthorized access, or operational failures. In this way, a platform 118 may be an infrastructure or orchestration system that enables the deployment, execution, and management of software assets 103 within a computing environment.

For example, an asset 103 may be deployed across multiple platforms 118 (e.g., cloud services, container orchestration systems, on-premises infrastructure) and operate within different environments 115 (e.g., development, testing, production). Vulnerabilities affecting an asset 103 may propagate across interconnected systems, impacting dependent services, data integrity, network performance, or security enforcement mechanisms.

The database system 106 may be system (e.g., a set of servers including a collection of memory, processing, and communication resources) responsible for detecting and categorizing vulnerabilities at assets 103, determining a network impact of the vulnerability at the asset 103 across other elements 119 in the communication network 100, and implementing a mitigation action to remediate the vulnerability at the asset 103 and across the other elements 119 in the communication network. The database system 106 may include an application 133 stored on a memory of the database system 106 and executable by a processor of the database system 106. As described herein, the application 133 may communicate with the data model system 109 to perform the methods described herein.

The database system 106 may also include a data store 136 (e.g., one or more distributed or co-located memories) for storing data that may be used by the application 133 to perform the operations discussed herein. For example, the data store 136 may store one or more policies 139, vulnerability data 156, network impact data 151, mitigation data 162, feedback data 160, historical data 161, and application dependency data 164. It should be appreciated that the data store 136 may store other types of data not shown in FIG. 1.

The policies 139 may each refer to logic or code defining one or more conditions that, when satisfied, may instruct the application 133 to perform one or more predefined tasks or operations (in some cases, by communicating with and/or using one or more applications at the data model system 109). The policies 139 may include, for example, a vulnerability policy 142, a network impact policy 145, and a mitigation action policy 148. The vulnerability policy 142 may include logic or code defining one or more conditions, which when satisfied, may instruct the application 133 (in some cases, using a vulnerability application 173 at the data model system 109) to detect one or more vulnerabilities across one or more assets 103 in the communication network 100 and to categorize the detected vulnerability into a predefined category. For example, the conditions evaluated in the vulnerability policy 142 may be based on the type of asset 103 detected as having the vulnerability, whether the software asset 103 includes a dependency with a known vulnerability (e.g., identified by a common vulnerabilities and exposures (CVE) database), whether the platform deploying the software asset 103 has a security configuration deviation, the potential impact of exploiting the vulnerability at the asset 103, whether compensating security protocols are in place at the asset 103, whether the asset 103 exhibits behaviors or patterns that deviate from established baselines, whether traffic characteristics at the asset 103 resemble known attack patterns, etc. (some of these factors may be determined based on the patterns and trends detected at the data model system 109 using historical data).

The network impact policy 145 may include logic or code defining one or more conditions, which when satisfied, may instruct the application 133 (e.g., in some cases, using a network impact application 176 executing at the data model system 109) to determine a network impact of the vulnerability at the asset 103, determine the other elements 119 in the communication network 100 that are likely to be impacted by the vulnerability at the asset 103 if exploited, a severity level of the impact at asset 103 and the elements 119, and/or a type of impact at asset 103 and the elements 119. For example, the conditions evaluated in the network impact policy 145 may include shared dependencies, direct network exposure, configuration or access linkage, physical or virtual network interconnectivity, data exposure impact, service disruption impact, security breach impact, performance degradation impact, propagation risk impact, etc. For example, if certain conditions are met between an asset 103 and an element 119 in the communication network 100 when the detected vulnerability is exploited or modeled as exploited, the element 119 may be deemed impacted by the vulnerability, the type of vulnerability may be determined, and the severity level or extent of the impact at the element 119 may be quantified (this information may be included in the network impact data 151). The application 133 may determine the network impact data 151 based on the network impact policy 145, in some cases, using the network impact application 176 at the data model system 109.

The mitigation action policy 148 may include logic or code defining one or more conditions, which when satisfied, may instruct the application 133 (e.g., in some cases, using a mitigation application 179 executing at the data model system 109) to determine an optimal mitigation action to perform to eliminate or reduce the risks that may result if the vulnerability at the asset 103 were to be exploited. For example, the mitigation action may involve patching the asset 103, reconfiguring the asset 103, resetting the asset 103, isolating the asset 103, or restricting access to the asset 103. The optimal mitigation action may be determined as one with a likelihood (e.g., confidence score) of success greater than a predefined threshold, in which the success may be based on a prior history of the mitigation having successfully reduced or eliminated the risks associated with prior similar vulnerabilities at similar assets 103.

In an embodiment, a mitigation action may be determined to address vulnerability only at the asset 103. In another embodiment, similar or different mitigation actions may be determined to address the vulnerability at the asset 103 and to address the potential risks at the impacted elements 119 (as indicated in the network impact data 151). In this embodiment, each of the asset 103 and the impacted elements 119 may be mitigated with the same type of mitigation action or with different mitigation actions (e.g., in some cases, different elements 119 may have different tasks in the mitigation action to address different application dependencies). For example, the conditions evaluated in the mitigation action policy 148 may be based on the type or category of the detected vulnerability, the type of asset 103 affected by the vulnerability, the network impact data 151 describing the impact of the vulnerability, etc.

The vulnerability data 156 may include data describing and categorizing the vulnerability detected at the asset 103. The vulnerability data 156 may include a vulnerability identifier 157 (shown in FIG. 1 as “vulnerability ID 157”), a category 158, and an asset identifier 149 (shown in FIG. 1 as “asset ID 149”). The vulnerability identifier 157 may be a name or value identifying the detected vulnerability at the asset 103. The category 158 may include a name or value indicating a category of the detected vulnerability determined by the application 133 (e.g., critical, low risk, etc.). The asset identifier 149 (shown in FIG. 1 as “vulnerability ID 145”) may include a name or location of the asset 103 at which the vulnerability was detected. The vulnerability data 156 may include other data not shown in FIG. 1. For example, the vulnerability data 156 may include an asset type (e.g., software or hardware, 5G core function-access and management function (AMF), subscriber database-home location register (HLR)), a detailed explanation of the vulnerability (e.g., a flaw in the authentication mechanism may allow unauthenticated API requests to execute arbitrary commands), exploitability of the vulnerability (e.g., whether the vulnerability can be exploited remotely, locally, or requires specific conditions), path/remediation availability (e.g., “patch available” or “no known fix”), etc.

The network impact data 151 may include data describing the network impact of a vulnerability detected at the asset 103. The network impact data 151 may generally refer to data that characterizes how a vulnerability in an asset 103 affects various elements 119 within the communications network 100. The network impact data 151 may include a network impact score 153 and/or a network impact report 155. In an embodiment, the network impact score 153 may be associated with the asset 103 alone and describe a general network impact of the vulnerability. In this case, the network impact score 153 may be a value reflecting a severity level of the vulnerability at the asset 103 generally across the communication network 100, if the vulnerability were to be exploited. In another embodiment, different network impact scores 153 may be respectively associated with the asset 103 and each of the impacted elements 119. In this case, the network impact score 153 for the asset 103 may be a value reflecting a severity level of the vulnerability in general across the communication network 100, while the network impact score 153 for each of the impacted elements 119 may refer to a severity level of the risk at the respective element 119 if the vulnerability at the asset 103 were to be exploited. For example, the network impact score 153 of the vulnerability at the asset 103 may be low, indicative of a low severity and a low risk across all the impacted elements 119. In some cases, the low network impact score 153 may be an indication that a mitigation action need not to be taken since the risk is relatively low, particularly when any mitigation action may cause more disruption than the exploitation of the vulnerability itself (and this comparison/balance between the disruption of the vulnerability versus the disruption of the mitigation action may be indicated in a mitigation action policy 148).

The network impact report 155 may be a report or document describing details of the vulnerability at the asset 103 and/or details of the risk across each the impacted elements 119. The network impact report 155 may help security teams, network operators, and system administrators understand the scope, severity, and required mitigation actions to address the vulnerability. The network impact report 155 may include data, such as for example, report metadata (e.g., report identifier, generated time/date, vulnerability identifier 157, etc.), a summary of the identified vulnerability (e.g., vulnerability name/brief description, affected asset 103, asset type (software/hardware), description of the vulnerability, exploitability-whether the vulnerability can be exploited remotely, locally, or requires specific conditions, patch remediation availability, etc.), an identification of the impacted elements and network impact (e.g., element name, element type, impact type, several level, propagation risk, etc.), network wide risk analysis, etc.

As mentioned above, the network impact report 155 may also be embodied as a knowledge graph. A knowledge graph is a structured representation of information where entities (e.g., elements, or elements having the identified vulnerabilities) are nodes, and the relationships between the entities (such as “connected to,” “has vulnerability,” or “impacts”) are edges between the nodes. To depict vulnerabilities and the associated network impact using a knowledge graph, each asset may be a node with associated properties, and/or each vulnerability can also be a node, linked to the affected assets through relationships (e.g., hasVulnerability). Metadata, such as identifiers, network impact scores, remediation statuses, etc., may be attached to each node as attributes. The network impact of a vulnerability may be modeled through relationships (e.g., impacts and/or propagatesTo), connecting a vulnerability to other nodes that may be indirectly affected—such as dependent services, connected hosts, or user-facing applications.

The network impact data 151 may include other data not shown in FIG. 1. For example, the network impact data 151 may include deployment metadata (e.g., platform type, environment type, network location), dependency mappings (e.g., relationships between assets 103, infrastructure components, and services), security exposure metrics (e.g., authentication logs, access patterns, known exploitability data), service impact assessments (e.g., potential degradation of network functions, risk of subscriber data exposure), and remediation status tracking (e.g., applied patches, mitigation effectiveness, unaddressed risk areas). In this way, the network impact data 151 may provide critical insights into the extent and severity of a vulnerability's propagation across multiple platforms 118 and environments 115, enabling precise identification of affected systems and prioritization of mitigation actions.

The mitigation data 162 may refer to data defining the operations, tasks, or corrective actions that may be taken to mitigate an identified vulnerability (eliminate or reduce the risk of the vulnerability, when exploited) at the asset 103 alone and/or at each of the impacted elements 119 within the communications network 100. The mitigation data 162 may include mitigation action instructions and/or recommendations, such as, for example, patch deployment instructions, configuration change recommendations, access control adjustments, network isolation strategies, traffic filtering rules, security policy updates, system rollback procedures, monitoring directives, etc. The mitigation data 162 may be generated dynamically and in an order of priority based on the severity, exploitability, and network impact of the vulnerability, ensuring that mitigation actions are executed in a targeted and efficient manner. The mitigation data 162 may also include dependencies between remediation tasks (e.g., based on application dependencies) to confirm successful resolution of the vulnerability while minimizing operational disruptions. In this way, the mitigation data 162 includes data defining operations or tasks to be performed to mitigate an identified vulnerability at an asset 103 and/or at each impacted element 119 within the communications network 100.

The feedback data 160 may include data indicating whether vulnerabilities identified at assets 103 were accurate or inaccurate, whether the network impact of the vulnerability was identified accurately or inaccurately, and whether the mitigation action was successful or not successful in eliminating or reducing the risk of the vulnerability. This data may be received, for example, via a device communicatively coupled to the database system 106 or directly from an operator of the database system 106 (e.g., via a user input into the database system 106).

The historical data 161 may be data collected by the database system 106 (e.g., from the one or more data stores 112) over an extended period of time. The historical data 161 may include historical ownership data, historical deployment data, historical environment data, historical vulnerability data, historical network impact data, and historical mitigation data. The historical ownership data may refer to data describing a team or individual at a business enterprise that may be responsible for controlling and operating prior assets 103 that were detecting as having vulnerabilities (e.g., an identifier or email address of the team or individual). The historical deployment data may refer to data describing the platforms 118 in which the prior assets 103 with vulnerabilities were deployed (e.g., identifications of the platforms 118 where prior assets 103 were deployed, whether the platform 118 is located on-premises or at a data center/cloud system, whether the platform 118 is a cloud computing service, container orchestration framework, virtualization environment, or other type of infrastructure, etc.). The historical environment data may include data describing the environments 115 in which the prior assets 103 with vulnerabilities were executed (e.g., whether the prior assets 103 were in a production or non-production environment, an identification of a stage in the software development lifecycle that the prior assets 103 were running, etc.). The historical network impact data may refer to data describing how the prior vulnerabilities at the asset 103 affected other elements 119 in the communications network. For example, the historical network impact data may include identifiers of the other elements 119 impacted by prior vulnerabilities, the severity/extent to which the other elements 119 were impacted (e.g., a quantification of the severity/extent), a description of the type of risk or issue that may occur if the prior vulnerability was exploited, etc. The historical mitigation data may include data describing the types of mitigation actions taken to resolve or mitigate the prior vulnerabilities at the assets 103 (e.g., applied patches, resets, throttling, etc.) and a status of the mitigation actions (e.g., mitigation effectiveness-successful/unsuccessful, unaddressed risk areas, etc.).

The application dependency data 164 may refer to data defining relationships, functional linkages, and operational dependences between assets 103 and other elements 119 the communication network 100. The application dependency data 164 may characterize how, for example, a software asset 103 interacts with, relies on, or provides services to other applications, libraries, APIs, infrastructure components, or network services. For example, application dependency data 164 may include service-level dependencies (e.g., microservices requiring upstream authentication services), software library dependencies (e.g., third-party packages integrated into an application), network-based dependencies (e.g., APIs used for data exchange across platforms), and deployment dependencies (e.g., an application requiring a specific configuration or cloud environment to function correctly). In the context of vulnerability mitigation, the application dependency data 164 may be used to determine whether a mitigation action at an impacted element 119 is contingent on prior remediation of another application, service, or component to prevent operational failures, data inconsistencies, or service disruptions. In this way, application dependency data 164 may include data defining the relationships between assets 103 and other elements 119 within the communications network 100, including service dependencies, software library dependencies, network-based dependencies, and deployment dependencies, which may impact the order or feasibility of vulnerability mitigation actions.

Therefore, the data in the data stores 112 and the data store 136 at the database system 106 generally include deployment metadata (e.g., platform types, environment types, network locations, etc.), dependency mappings (e.g., relationships between assets, infrastructure components, services, etc.), security exposure metrics (e.g., authentication logs, access patterns, exploitable data, etc.). This data, collectively, may be advantageous for evaluation using the data model system 109 for accurately determining the presence of vulnerabilities in the communication network 100.

In some cases, data regarding potential vulnerabilities may be received from external sources as well as being determined by the database system 106 using the data model system 109. Such data may be received from, for example, an external system 121. The external system 121 may refer to an underlying computing environment, external to the database system 106, that may store and provide vulnerability data 156 (e.g., in a data store 165 at the external system 121). For example, the external system 121 may include the common vulnerabilities and exposures (CVE database), which may be a repository cataloging publicly disclosed cybersecurity vulnerabilities, each identified by a CVE identifier. CVE databases may store detailed vulnerability information and may be maintained by third party organizations. The application 133 at the database system 106 may query the CVE database to detect vulnerabilities that may affect the assets 103. As another example, the external system 121 may refer to a competitor database, which publicly discloses vulnerabilities identified in similar network assets 103 and/or elements 119 in the network of a competitor. The application 133 at the database system 106 may query the external system 121 to detect vulnerabilities that may exist at similar assets 103 and/or elements 119.

The data model system 109 may be implemented as a server or computer system, including one or more processors and memories storing instructions associated with a machine learning model 170, a vulnerability application 173, a network impact application 176, and a mitigation application 179. The machine learning model 170 may work with the vulnerability application 173, network impact application 176, and the mitigation application 179, and leverage algorithms and statistical techniques to analyze input features of and identify patterns to detect vulnerabilities at assets 103, determine the network impact of the vulnerability, and implement an optimal mitigation action to address the vulnerability at the asset 103 and/or the impacted elements 119. The machine learning model 170 may be implemented using software (e.g., algorithms, logic, and code) stored across one or more memories, and the underlying hardware of the data model system 109 may provide the computational resources for execution of the machine learning model 170. The machine learning model 170 may be implemented as one or more different types of models using, for example, linear regression, decision trees, support vector machines, neural networks, or ensemble methods. It should be appreciated that any type of machine learning model 170 may be used, and the underlying algorithms, computations, and machine learning libraries used by the model should not be limited herein.

The vulnerability application 173, network impact application 176, and the mitigation application 179 may each be instructions stored across one or more memories of the data model system 109 that may be executable by one or more processors of the data model system 109. The vulnerability application 173 may be trained to detect vulnerabilities at assets 103 (to generate a vulnerability identifier 157 and asset identifier 149) and categorize the vulnerability (to generate a category 158) based on a vulnerability policy 142. The network impact application 176 may be trained to determine a network impact (and the network impact data 151) for the identified vulnerability using a network impact policy 145. The mitigation application 179 may be trained to determine an optimal mitigation action to implement at the asset 103 and/or at each of the impacted elements 119 (to generate the mitigation data 162).

The data model system 109 may also include a data store 166 (e.g., one or more distributed or co-located memories). The data store 166 may store training data 167 that may be used to train the machine learning model 170, vulnerability application 173, network impact application 176, and mitigation application 179. The training data 167 may include historical data 161, which may be collected from one or more data stores 112 over an extended period of time as described above.

The data stores 112 may be a collection of one or more memories (co-located or distributed across different data centers), which are accessible by the database system 106. The data stores 112 may be located in, for example, in a core network of the communications network 100 or one of the platforms 118. The data stores 112 may be accessible by the application 133 of the database system 106. As shown in FIG. 1, the data store 112 may store ownership data 126, deployment data 128, and environment data 129. The ownership data 126 may include current (and/or historical) data describing a team or individual at a business enterprise that may be responsible for controlling and operating assets 103 with vulnerabilities (e.g., an identifier or email address of the team or individual). The deployment data 128 may include current (and/or historical) data describing the platforms 118 in which the assets 103 with vulnerabilities are/were deployed (e.g., identifications of the platforms 118 where assets 103 are/were deployed, whether the platform 118 is/was located on-premises or at a data center/cloud system, whether the platform 118 is/was a cloud computing service, container orchestration framework, virtualization environment, or other type of infrastructure, etc.). The environment data 129 may include current (and/or historical) data describing the environments 115 in which the assets 103 with vulnerabilities are/were executed (e.g., whether the assets 103 are/were in a production or non-production environment, an identification of a stage in the software development lifecycle that the assets 103 are/were tagged in, etc.).

While the data stores 112, assets 103, database system 106, data model system 109, environments 115, platforms 118, elements 119, and external systems 121 are shown in FIG. 1 as being separate from one another, one or more of the data stores 112, assets 103, database system 106, data model system 109, environments 115, platforms 118, elements 119, and external systems 121 may be physically or logically together across a single (co-located or distributed) set of servers. For example, the data model system 109 may be part of the database system 106, or the data model system 109 may be separate from the database system 106.

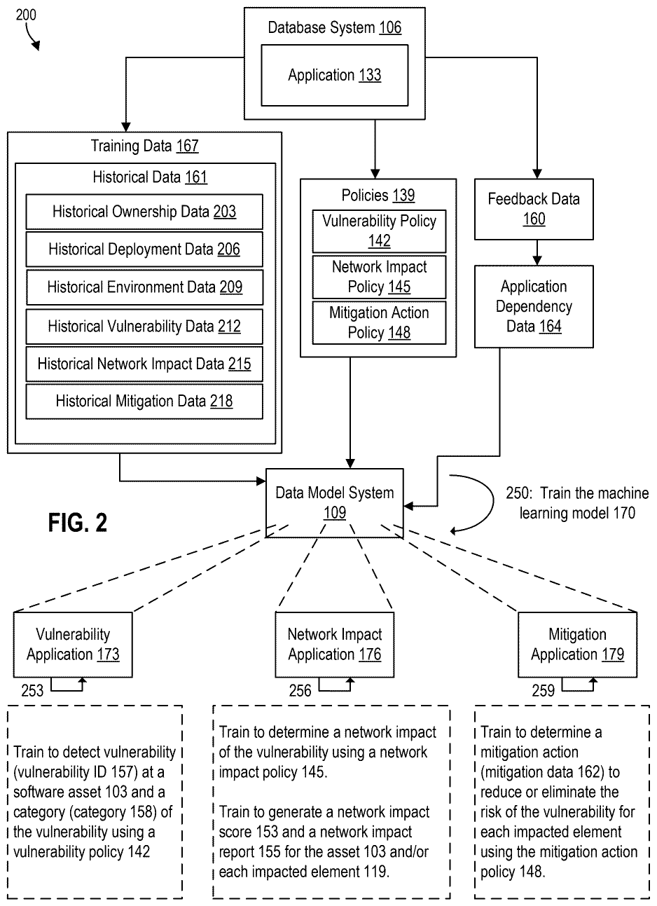

Referring now to FIG. 2, shown is a diagram illustrating the training of the data model system 109 according to various embodiments of the disclosure. As shown in FIG. 2 and described above, the data model system 109 includes the vulnerability application 173, network impact application 176, and mitigation application 179.

The application 133 at the database system 106 may provide training data 167 and other data to the data model system 109 to perform operation 250 to train the machine learning model 170. More specifically, the training data 167 and other data may be used to train the vulnerability application 173, network impact application 176, and mitigation application 179 at the data model system 109, each of which may operate using the algorithms, parameters, weights, etc. of the machine learning models 170 programmed at the data model system 109.

The training data 167 includes historical data 161 describing prior detected vulnerabilities across the communication network 100. The historical data 161 may include historical ownership data 203, historical deployment data 206, historical environment data 209, historical vulnerability data 212, historical network impact data 215, and historical mitigation data 218. The historical ownership data 203 may refer to data describing a team or individual at a business enterprise that may be responsible for controlling and operating prior assets 103 with vulnerabilities (e.g., an identifier or email address of the team or individual). This historical ownership data 203 may be used to train the data model system 109 (the machine learning model 170) to identify patterns and trends in vulnerabilities identified at assets 103 previously controlled/managed by the same individuals or teams.

The historical deployment data 206 may refer to data describing the platforms 118 in which the prior assets 103 with vulnerabilities were deployed (e.g., identifications of the platforms 118 where prior assets 103 were deployed, whether the platform 118 is located on-premises or at a data center/cloud system, whether the platform 118 is a cloud computing service, container orchestration framework, virtualization environment, or other type of infrastructure, etc.). The historical deployment data 206 may be used to train the data model system 109 (the machine learning model 170) to identify patterns and trends in how a vulnerability at one asset 103 may impact other elements 119 across different platforms 118.

The historical environment data 209 may include data describing the environments 115 in which the prior assets 103 with vulnerabilities were executed (e.g., whether the prior assets 103 were in a production or non-production environment, an identification of a stage in the software development lifecycle that the prior assets 103 were running, etc.). The historical environment data 209 may be used to train the data model system 109 (the machine learning model 170) to identify patterns and trends in how a vulnerability at one asset 103 may impact other elements 119 running in different environments 115.

The historical vulnerability data 212 may refer to the vulnerability data 156 of the prior vulnerabilities at the assets 103 determined by the application 133. The historical vulnerability data 212 may be used to train the data model system 109 (the machine learning model 170) to identify patterns and trends across similar types/categories of vulnerabilities across similar assets 103.

The historical network impact data 215 may refer to data describing how the prior vulnerabilities at the asset 103 affected other elements 119 in the communications network 100. The historical network impact data 215 may be used to train the data model system 109 (the machine learning model 170) to identify patterns and trends in how a vulnerability at one asset 103 may impact other elements 119 in the communication network 100 (e.g., the severity/extent of the impact, the type of the impact, etc.).

The historical mitigation data 218 may include data describing the types of mitigation actions taken to resolve or mitigate the prior vulnerabilities at the assets 103 (e.g., applied patches, resets, throttling, etc.) and a status of the mitigation actions (e.g., mitigation effectiveness, unaddressed risk areas, etc.). The historical mitigation data 218 may be used to train the data model system 109 (the machine learning model 170) to identify patterns and trends in how a risk of the vulnerability at one asset 103 may be reduced or eliminated in response to various mitigation actions, tasks, or operations.

The other data that may be provided to the data model system 109 to perform operation 250 to train the machine learning model 170 may include the policies 139, the feedback data 160, and the application dependency data 164. The policies 139 provided to the data model system 109 may include vulnerability policy 142, network impact policy 145, and the mitigation action policy 148 described above. As defined above with respect to FIG. 1, the feedback data 160 may indicate the accuracy of the determinations and predictions made by the data model system 109, and the application dependency data 164 may refer to data defining relationships, functional linkages, and operational dependences between assets 103 and other elements 119 the communication network 100. The policies 139, feedback data 160, and application dependency data 164 may be used to further train and/or refine the applications, machine learning algorithms, parameters, weights, etc., at the data model system 109 to dynamically make more accurate determinations and predictions based on the input data provided to the data model system 109.

At operation 250, the algorithms, weights, and other parameters of the machine learning model 170 at the data model system 109 may be trained (or refined for more accuracy) based on the training data 167, policies 139, feedback data 160, and/or application dependency data 164. In particular, each of the vulnerability application 173, network impact application 176, and mitigation application 179 may be programmatically trained based on the relevant training data 167. For instance, each of the vulnerability application 173, network impact application 176, and mitigation application 179 may be associated with one or more machine learning algorithms (each programmed differently to output predictions with higher confidence scores based on the particular type of input data provided). The policies 139, feedback data 160, and/or application dependency data 164 may be used to train each of the one or more machine learning algorithms associated with each of the vulnerability application 173, network impact application 176, and mitigation application 179 in different manners, such that different algorithms may be selected dynamically based on input data to produce better prediction results based on the input data type.

At operation 253, the vulnerability application 173 may be trained to detect a vulnerability at an asset 103 (e.g., generate the vulnerability identifier 157, asset identifier 149, and other vulnerability data 156), and categorize the vulnerability at the asset 103. The vulnerability application 173 may be trained to identify the vulnerabilities at assets 103 based on the vulnerability policies 142 received from the application 133. For example, the historical data 161 may be labeled or unlabeled examples that may be evaluated by the vulnerability application 173 (e.g., the machine learning model/algorithm used by the vulnerability application 173). The vulnerability application 173 may learn patterns and relationships within the historical data 161 using the policies 139, feedback data 160, and/or application dependency data 164. This learning may enable the vulnerability application 173 to make predictions on current data based on the patterns and trends detected using the historical data 161, policies 139, feedback data 160, and/or application dependency data 164.

Once trained, the vulnerability application 173 may be used to identify, describe, and categorize a vulnerability at an asset 103 (e.g., based on the training of the vulnerability application 173 using the historical vulnerability data 212 and historical ownership data 203). For example, the vulnerability application 173 may be trained to output the vulnerability data 156 of the detected vulnerability at the asset 103, including the vulnerability identifier 157, the category 158, and the asset identifier 149.

At operation 256, the network impact application 176 may be trained to determine a network impact of the vulnerability using a network impact policy 145. Specifically, the network impact application 176 may be trained to generate a network impact score 153 and/or a network impact report 155 for the asset 103 and/or each impacted element 119 in the communication network 100. For example, the historical data 161 may be labeled or unlabeled examples that may be evaluated by the network impact application 176 (e.g., the machine learning model/algorithm used by the network impact application 176). The network impact application 176 may learn patterns and relationships within the historical data 161 using the policies 139, feedback data 160, and/or application dependency data 164. This learning may enable the network impact application 176 to make predictions on current data based on the patterns and trends determined using the historical data 161, policies 139, feedback data 160, and/or application dependency data 164.

Once trained, the network impact application 176 may be used to generate the network impact data 151 (e.g., the network impact scores 153 and/or the network impact report 155) for the asset 103 at which the vulnerability is identified and/or for each element 119 impacted by the vulnerability. The network impact data 151 may be generated using a network impact policy 145 (e.g., based on the training of the network impact application 176 using the historical vulnerability data 212, current incoming vulnerability data 156, historical network impact data 215, historical ownership data 203, historical deployment data 206, and/or the historical environment data 209). For example, the network impact application 176 may be trained to output the network impact data 151 of the detected vulnerability at the asset 103. The network impact data 151 may include a network impact score 153 for the asset 103 and generally describing the network impact of the vulnerability across the communication network 100, or a network impact score 153 for not only the asset 103 but also for each impacted element 119 (e.g., identifying the impacted elements 119, describing the type of impact at the impacted elements 119, and quantifying a severity level of the impact at the impacted elements 119).

At operation 259, the mitigation application 179 may be trained to determine an optimal mitigation action (or to generate mitigation data 162 describing the optimal mitigation action) based on vulnerability data 156 determined by the vulnerability application 173, network impact data 151 determined by the network impact application 176, and/or a mitigation action policy 148. The mitigation action may be for only the asset 103, and the impacted elements 119. The mitigation action may be the same across the asset 103 and/or the impacted elements 119, may be different across each of the asset 103 and the impacted elements 119, or combinations thereof. For example, the historical data 161 may be labeled or unlabeled examples that may be evaluated by the mitigation application 179 (e.g., the machine learning model/algorithm used by the mitigation application 179). The mitigation application 179 may learn patterns and relationships within the historical data 161 using the policies 139, feedback data 160, and/or application dependency data 164. This learning may enable the network impact application 176 to make predictions on current data based on the patterns and trends determined using the historical data 161, policies 139, feedback data 160, and/or application dependency data 164.

Once trained, the mitigation application 179 may be used to generate the mitigation data 162 for the asset 103 at which the vulnerability is identified and/or for each element 119 impacted by the vulnerability. The mitigation data 162 may be generated using a mitigation action policy 148 (e.g., based on the training of the mitigation application 179 using the historical vulnerability data 212, current incoming vulnerability data 156, historical network impact data 215, current network impact data 151, and/or historical mitigation data 218). For example, the mitigation application 179 may be trained to output the mitigation data 162 of the detected vulnerability at the asset 103. As mentioned above, mitigation data 162 may be generated dynamically based on the severity, exploitability, and network-wide impact of the vulnerability, ensuring that mitigation actions are executed in a targeted and efficient manner. The mitigation data 162 may also include dependencies between remediation tasks, prioritization metrics, and validation steps to confirm successful resolution of the vulnerability while minimizing operational disruptions.

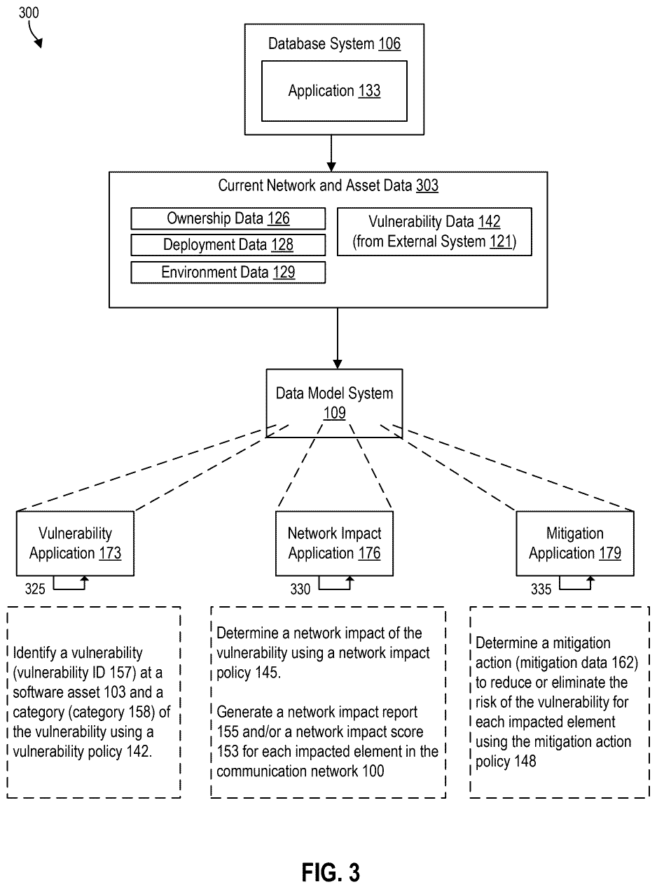

Referring now to FIG. 3, shown is a diagram illustrating the use of the different applications in the data model system 109 to detect and address vulnerabilities across the communication network 100 according to various embodiments of the disclosure. The application 133 at the database system 106 gathers current network and asset data 303, including current, up-to-date ownership data, deployment data, and infrastructure data across various assets and elements in the communication network collected over a predefined period of time.

The current network and asset data 303 may include the most recently collected ownership 126 data describing the ownership of assets 103, deployment data 128 describing platforms 118 at which assets 103 are deployed, environment data 129 describing environments 115 in which assets 103 are running, and/or vulnerability data 156 describing known vulnerabilities from external systems 121. In this way, the current network and asset data 303 may refer to an updated set of data that may be used to detect and categorize vulnerabilities at assets 103 in the communication network 100, determine a network impact of the vulnerabilities across other elements 119 in the communication network 100, and implement an optimal mitigation action to address and potentially resolve the detected vulnerability. The current network and asset data 303 may collectively provide a comprehensive snapshot of the assets 103 being utilized across the communication network 100, the ownership of the assets 103, the deployment of the assets 103 at various platforms 118, and the execution of the assets 103 across various environments 115.

The data model system 109 may receive the current network and asset data 303 as input through an automated data pipeline that aggregates, normalizes, and structures the information for analysis. The vulnerability application 173, network application 176, and mitigation application 179 may continuously learn from updated current network and asset data 303. In this way, the vulnerability application 173, network impact application 176, and mitigation application 179 may continuously refine the predictive accuracy to adapt to evolving network conditions and user behaviors.

The data model system 109 may first filter the current network and asset data 303 (and remove unnecessary or unrelated data items) to obtain filtered current network and asset data 303. For example, the filtering operation may be performed on an asset-by-asset basis (to evaluate the condition of each asset 103 to determine whether the related ownership data 126, deployment data 128, and/or environment data 129 may have to be provided to the data model system 109 or not), to filter out unnecessary data in the current network and asset data 303 prior to providing the current network and asset data 303 to the data model system 109.

The application 133 may use the vulnerability application 173 to perform operation 325, to detect the vulnerability and generate vulnerability data 156 describing the vulnerability. More specifically, the application 133 may use the vulnerability application 173 to detect a vulnerability at an asset 103 (e.g., generate the vulnerability identifier 157, asset identifier 149, and other vulnerability data 156), and categorize the vulnerability at the asset 103 using, for example, a vulnerability policy 142. Again, the vulnerability application 173 may be trained to detect the vulnerability at the asset 103 and categorize the vulnerability based on an evaluation of the current network and asset data 303 using a vulnerability policy 142. The vulnerability policy 142 may define one or more conditions based on various factors (e.g., the type of asset 103 detected as having the vulnerability, whether the asset 103 includes a dependency with a known vulnerability, whether the platform deploying the asset 103 has a security configuration deviation, the potential impact of exploiting the vulnerability at the asset 103, whether compensating security protocols are in place at the asset 103, whether the asset 103 exhibits behaviors or patterns that deviate from established baselines, whether traffic characteristics at the asset 103 resemble known attack patterns, etc.).

At operation 330, the application 133 may use the network impact application 176 to determine a network impact of the vulnerability using a network impact policy 145 (e.g., generate network impact data 151) based on the current network and asset data 303 (collected over a period of time), the vulnerability data 156 identified at operation 325, and a network impact policy 145. Again, the network impact application 176 may be trained to generate a network impact score 153 and/or a network impact report 155 for the asset 103 and/or each impacted element 119 in the communication network 100 using a network impact policy 145. The network impact policy 145 may define one or more conditions based on various factors (e.g., shared dependencies, direct network exposure, configuration or access linkage, physical or virtual network interconnectivity, data exposure impact, service disruption impact, security breach impact, performance degradation impact, propagation risk impact, etc.).

At operation 335, the application 133 may use the mitigation application 179 to determine an optimal mitigation action to perform to eliminate or reduce the risks that may result if the vulnerability at the asset 103 were to be exploited based on the current network and asset data 303, the vulnerability data 156 generated at operation 325, the network impact data 151 generated at operation 330, and a mitigation action policy 148. Again, the mitigation application 179 may be trained to determine the optimal mitigation action for the asset 103 alone and/or each of the impacted elements 119, and the output of the mitigation application 179 may be mitigation data 162 describing the respectively determined mitigation actions. The mitigation action policy 148 may define one or more conditions based on various factors. For example, a mitigation action policy 148 may define predefined mitigation actions for specific categories 158 of vulnerabilities and/or different types of assets 103 at which the vulnerabilities were detected. Additionally or alternatively, the mitigation action may be determined to be optimal based on the historical mitigation action data 218 describing that similar mitigation actions have had a higher than threshold percent success rate in reducing or eliminating the risk of the vulnerability. For example, the determined optimal mitigation action may have a likelihood (higher than a threshold) of successfully resolving the vulnerability.

For example, the mitigation action policy 148 may indicate that the optimal mitigation action should only be performed on the asset 103 and/or the impacted element 119 if the network impact score 153 meets or exceeds a predefined threshold (also indicated in the mitigation action policy 148). In this case, when the network impact score 153 is less than or equal to the predefined threshold, the risk of the vulnerability and impact may not be high enough to perform disruptive mitigation actions that may or may not successfully remove the risk of the vulnerability, or the disruptions caused by the mitigation actions may not be warranted given the low risk of the vulnerability as indicated by the network impact score 153. As mentioned above, the asset 103 and each impacted element 119 may have a different network impact score 153, and thus the determination of whether the network impact score 153 meets or exceeds the predefined threshold may be performed for the asset 103 at which the vulnerability is detected and for each impacted element 119 separately.

Once the application 133 obtains (e.g., generates/determines) the mitigation data 162 describing the optimal mitigation action to be performed at the asset 103 and/or at one or more of the impacted elements 119, the application 133 may begin performing the optimal mitigation action again at either only the asset 103 and/or across one or more impacted elements 119 either in sequence or in parallel. For example, suppose the network impact data 151 indicates that the network impact of the vulnerability is severe because the vulnerability may remove security barriers otherwise intended to protect sensitive customer data. In this case, the vulnerability may be associated with a critically high network impact score 153, and the optimal mitigation action may be for the application 133 to temporarily shut down services provided by not only the asset 103 but all the impacted elements 119 (to prevent any risk of the sensitive customer data being compromised) until the vulnerability can be completely removed (e.g., with a software patch or a hardware reset).

As another example, suppose the network impact data 151 indicates that the network impact of the vulnerability is low because the vulnerability impairs functioning of an internal application (e.g., the asset 103) used for inter-enterprise messaging and notifications. In this case, the vulnerability may be associated with a lower network impact score 153, and the optimal mitigation action may be for the application 133 to send a software patch to the vulnerable internal application to resolve the impaired functioning of the internal application (impacted elements 119 may not need to be addressed since the network impact score 153 is lower than a predefined threshold). And, this mitigation action may be given a much lower priority than the aforementioned mitigation action to temporarily shut down the services provided by the asset 103 and the impacted elements 119. In this way, the application 133 may triage or prioritize different mitigation actions based on the network impact data 151 associated with each vulnerability and the severity of the risk associated with the vulnerability, to ensure performance of the optimal mitigation action in a timely manner and to prevent service disruptions, network failures, and security breaches.

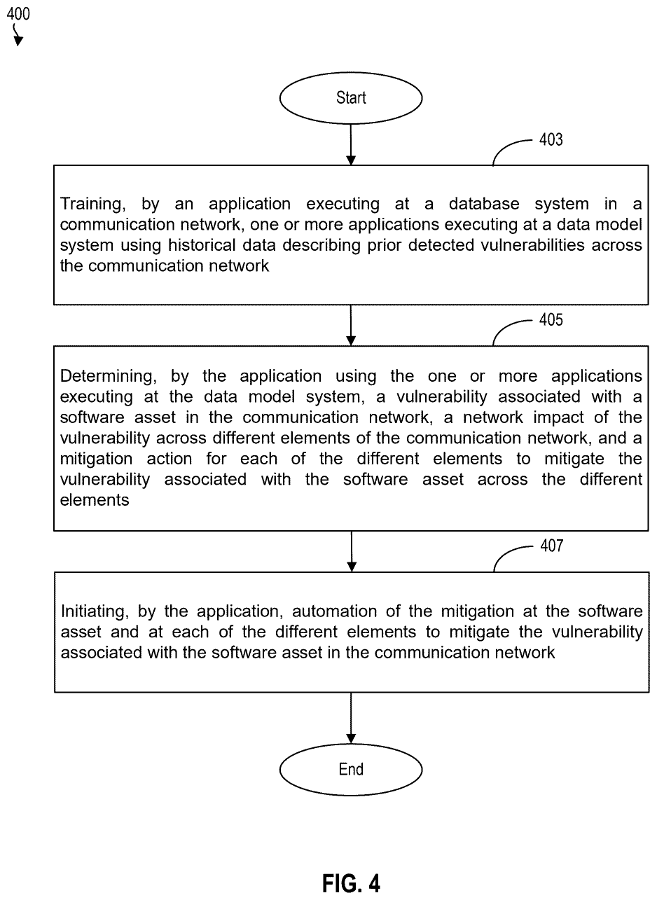

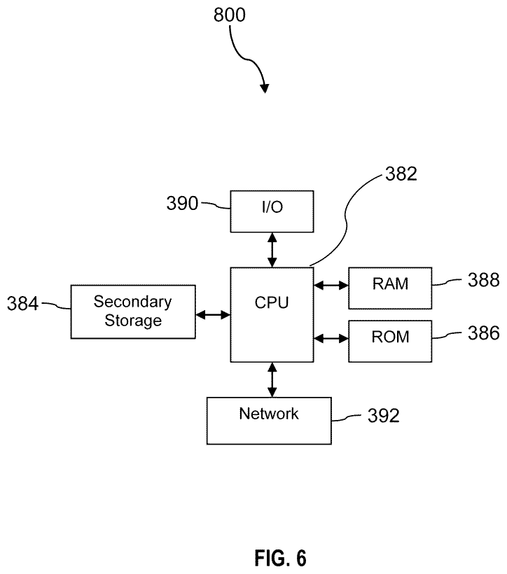

Referring now to FIG. 4, shown is a method 400 of vulnerability evaluation and mitigation in the communication network 100 of FIG. 1 according to various embodiments of the disclosure. Method 400 may be implemented by the application 133 in the database system 106 using the data model system 109. In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 comprises training, by an application 133 executing at a database system 106 in a communication network 100, one or more applications (e.g., the vulnerability application 173, the network impact application 176, and the mitigation application 179) executing at a data model system 109 using historical data 161 describing prior detected vulnerabilities across the communication network 100. At step 405, method 400 comprises determining, by the application 133 using the one or more applications executing at the data model system 109, a vulnerability associated with a software asset 103 in the communication network 100, a network impact of the vulnerability across different elements 119 of the communication network 100, and a mitigation action for each of the different elements 119 to mitigate the vulnerability associated with the software asset 103 across the different elements 119. At step 407, method 400 comprises initiating, by the application 133, automation of the mitigation at the software asset 103 and at each of the different elements 119 to mitigate the vulnerability associated with the software asset 103 in the communication network.

Method 400 may include other steps and/or features that are not otherwise shown in FIG. 4. In an embodiment, the historical data 161 describing the prior detected vulnerabilities across the communication network 100 comprises at least one of historical vulnerability data 212 describing the prior detected vulnerabilities, historical ownership data 203 describing ownership of one or more software assets 103 at which the prior detected vulnerabilities occurred, historical deployment data 206 describing platforms at which the prior detected vulnerabilities occurred, or historical environment data 209 describing environments at which the prior detected vulnerabilities occurred. In an embodiment, wherein the software asset 103 is at least one of an application, a library, a framework, an application programming interface, a dataset, or a programming language.

In an embodiment, the vulnerability is at least one of a defect, a weakness, or a misconfiguration in the software asset 103 that, when exploited, is likely to compromise at least one of an integrity, an availability, a confidentiality, or a functionality of the software asset 103 or the communication network 100. In an embodiment, the network impact of the vulnerability refers to cascading effects that the vulnerability at the software asset is likely to have across the different elements 119 of the communications network leading to at least one of a disruption, a security breach, or a functional impairment at the different elements 119 in the communications network 100. In an embodiment, the different elements 119 in the communications network 100 are located in at least one of a platform 118, an environment 115, or an interconnected system.

In an embodiment, the mitigation action refers to one or more tasks that are implemented to reduce or eliminate a risk of the vulnerability being exploited at the software asset 103 and at the different elements 119 in the communication network 100. In an embodiment, the mitigation action comprises at least one of patching, reconfiguring, isolating, or restricting access to the software asset 103. In an embodiment, each of the one or more applications executing at the data model system 109 uses a machine learning model 170 executing at the data model system 109.

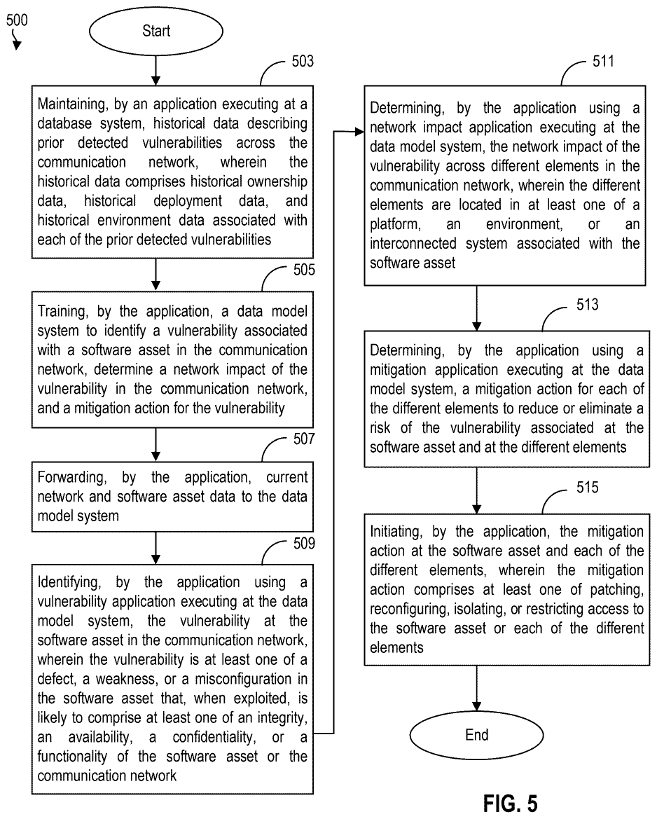

Referring now to FIG. 5, shown is a method 500 of vulnerability evaluation and mitigation in the communication network 100 of FIG. 1 according to various embodiments of the disclosure. Method 500 may be implemented by the application 133 in the database system 106 using the data model system 109. In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises maintaining, by an application 133 executing at a database system 106, historical data 161 describing prior detected vulnerabilities across the communication network 100. In an embodiment, the historical data 161 comprises historical ownership data 203, historical deployment data 206, and historical environment data 209 associated with each of the prior detected vulnerabilities.

At step 505, method 500 comprises training, by the application 133, a data model system 109 to identify a vulnerability associated with a software asset 103 in the communication network 100, determine a network impact of the vulnerability in the communication network 100, and a mitigation action for the vulnerability. At step 507, method 500 comprises forwarding, by the application 133, current network and software asset data 303 to the data model system 109.

At step 509, method 500 comprises identifying, by the application 133 using a vulnerability application 173 executing at the data model system 109, the vulnerability at the software asset 103 in the communication network 100. In an embodiment, the vulnerability is at least one of a defect, a weakness, or a misconfiguration in the software asset 103 that, when exploited, is likely to comprise at least one of an integrity, an availability, a confidentiality, or a functionality of the software asset 103 or the communication network 100. At step 511, method 500 may determining, by the application 133 using a network impact application 176 executing at the data model system 109, the network impact of the vulnerability across different elements 119 in the communication network 100. In an embodiment, the different elements 119 are located in at least one of a platform 118, an environment 115, or an interconnected system associated with the software asset 103.

At step 513, method 500 comprises determining, by the application 133 using a mitigation application 179 executing at the data model system 109, a mitigation action for each of the different elements 119 to reduce or eliminate a risk of the vulnerability at the software asset 103 and at the different elements 119. At step 515, method 500 comprises initiating, by the application 133, the mitigation action at the software asset 103 and each of the different elements 119. In an embodiment, the mitigation action comprises at least one of patching, reconfiguring, isolating, or restricting access to the software asset 103 or each of the different elements 119.

Method 500 may include other steps and/or features that are not otherwise shown in FIG. 5. In an embodiment, the historical ownership data 203 describes ownership of one or more software assets 103 at which the prior detected vulnerabilities occurred, and the ownership is based on at least one team responsible for owning or operating the one or more software assets 103. In an embodiment, the historical deployment data 206 describes platforms 118 at which the prior detected vulnerabilities occurred, and each of the platforms 118 is a system that provides resources for deploying, managing, and operating one or more software assets 103 associated with the prior detected vulnerabilities. In an embodiment, the historical environment data 209 describes environments 115 at which the prior detected vulnerabilities occurred, and the environments 115 are associated with a software development lifecycle and comprise a development environment, an integration environment, a test environment, a staging environment, and a production environment.

In an embodiment, the software asset 103 is at least one of an application, a library, a framework, an application programming interface, a dataset, or a programming language. In an embodiment, the network impact of the vulnerability refers to cascading effects that the vulnerability of the software asset 103 is likely to have across the different elements 119 of the communications network 100 leading to at least one of a disruption, a security breach, or a functional impairment at the different elements 119 in the communications network 100.

FIG. 6 illustrates a computer system 800 suitable for implementing one or more embodiments disclosed herein. In an embodiment, software asset 103, database system 106, data model system 109, data stores 112, environments 115, platforms 118, elements 119, etc., may each be implemented as the computer system 800. The computer system 800 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 800, at least one of the CPU 382, the RAM 388, and the ROM 386 are changed, transforming the computer system 800 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 800 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 800 to provide the functionality of a number of servers that is not directly bound to the number of computers in the computer system 800. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 800, at least portions of the contents of the computer program product to the secondary storage 384, to the ROM 386, to the RAM 388, and/or to other non-volatile memory and volatile memory of the computer system 800. The processor 382 may process the executable instructions and/or data structures in part by directly accessing the computer program product, for example by reading from a CD-ROM disk inserted into a disk drive peripheral of the computer system 800. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 800.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 800 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for vulnerability evaluation and mitigation in a communication network, wherein the method comprises:
maintaining, by an application executing at a database system, historical data describing prior detected vulnerabilities across the communication network, wherein the historical data comprises historical ownership data, historical deployment data, and historical environment data associated with each of the prior detected vulnerabilities;
training, by the application, a data model system to identify a vulnerability associated with a software asset in the communication network, determine a network impact of the vulnerability in the communication network, and a mitigation action for the vulnerability;
forwarding, by the application, current network and software asset data to the data model system;
identifying, by the application using a vulnerability application executing at the data model system, the vulnerability at the software asset in the communication network, wherein the vulnerability is at least one of a defect, a weakness, or a misconfiguration in the software asset that, when exploited, is likely to comprise at least one of an integrity, an availability, a confidentiality, or a functionality of the software asset or the communication network;
determining, by the application using a network impact application executing at the data model system, the network impact of the vulnerability across different elements in the communication network, wherein the different elements are located in at least one of a platform, an environment, or an interconnected system associated with the software asset;
determining, by the application using a mitigation application executing at the data model system, a mitigation action for each of the different elements to reduce or eliminate a risk of the vulnerability associated at the software asset and at the different elements; and
initiating, by the application, the mitigation action at the software asset and each of the different elements, wherein the mitigation action comprises at least one of patching, reconfiguring, isolating, or restricting access to the software asset or each of the different elements.

2. The method of claim 1, wherein the historical ownership data describes ownership of one or more software assets at which the prior detected vulnerabilities occurred, wherein the ownership is based on at least one team responsible for owning or operating the one or more software assets.

3. The method of claim 1, wherein the historical deployment data describes platforms at which the prior detected vulnerabilities occurred, wherein each of the platforms is a system that provides resources for deploying, managing, and operating one or more software assets associated with the prior detected vulnerabilities.

4. The method of claim 1, wherein the historical environment data describes environments at which the prior detected vulnerabilities occurred, and wherein the environments are associated with a software development lifecycle and comprise a development environment, an integration environment, a test environment, a staging environment, and a production environment.

5. The method of claim 1, wherein the software asset is at least one of an application, a library, a framework, an application programming interface, a dataset, or a programming language.

6. The method of claim 1, wherein the network impact of the vulnerability refers to cascading effects that the vulnerability of the software asset is likely to have across the different elements of the communications network leading to at least one of a disruption, a security breach, or a functional impairment at the different elements in the communications network.

7. A system, comprising:
a non-transitory memory configured to store historical data describing prior detected vulnerabilities across a communication network, wherein the historical data comprises historical ownership data, historical deployment data, historical environment data, historical network impact data, and historical mitigation data associated with each of the prior detected vulnerabilities;
a processor communicatively coupled to the memory; and
an application stored at the memory, which when executed by the processor, causes the processor to be configured to:
train a data model system using the historical data to identify a vulnerability associated with a software asset in the communication network, determine a network impact of the vulnerability in the communication network, and a mitigation action for the vulnerability;
identify, using a vulnerability application executing at the data model system, the vulnerability at the software asset in the communication network;
determine, using a network impact application executing at the data model system, a network impact of the vulnerability across different elements in the communication network, wherein the different elements are located in at least one of a platform, an environment, or an interconnected system associated with the software asset; and
determine, using a mitigation application executing at the data model system, a mitigation action to perform at the software asset and at each of the different elements to reduce or eliminate a risk of the vulnerability associated with the software asset at the software asset and at each of the different elements, wherein the mitigation action comprises at least one of patching, reconfiguring, isolating, or restricting access to at least one of the software asset or the different elements.

8. The system of claim 7, wherein the vulnerability is at least one of a defect, a weakness, or a misconfiguration in the software asset that, when exploited, is likely to comprise at least one of an integrity, an availability, a confidentiality, or a functionality of the software asset or the communication network.

9. The system of claim 7, wherein the software asset is at least one of an application, a library, a framework, an application programming interface, a dataset, or a programming language.

10. The system of claim 7, wherein the network impact of the vulnerability refers to cascading effects that the vulnerability of the software asset is likely to have across the different elements of the communications network leading to at least one of a disruption, a security breach, or a functional impairment at the different elements in the communications network.

11. The system of claim 7, wherein the mitigation action refers to one or more tasks that are implemented to reduce or eliminate a risk of the vulnerability being exploited at the software asset and the different elements in the communication network.

12. The system of claim 7, wherein the historical network impact data describes a prior network impact of each of the prior detected vulnerabilities, wherein the prior network impact defines at least one of the platform, the environment, or the interconnected system affected by a prior detected vulnerability.

13. The system of claim 7, wherein the historical mitigation data describes a prior mitigation action that successfully reduced or eliminated a risk of the vulnerability being exploited at the different elements in the communication network.

14. A method comprising:
training, by an application executing at a database system in a communication network, one or more applications executing at a data model system using historical data describing prior detected vulnerabilities across the communication network;
determining, by the application using the one or more applications executing at the data model system, a vulnerability associated with a software asset in the communication network, a network impact of the vulnerability across different elements of the communication network, and a mitigation action for each of the different elements to mitigate the vulnerability associated with the software asset across the different elements; and
initiating, by the application, automation of the mitigation action at the software asset and at each of the different elements to mitigate the vulnerability associated with the software asset in the communication network.

15. The method of claim 14, wherein historical data describing the prior detected vulnerabilities across the communication network comprises at least one of historical vulnerability data describing the prior detected vulnerabilities, historical ownership data describing ownership of one or more software assets at which the prior detected vulnerabilities occurred, historical deployment data describing platforms at which the prior detected vulnerabilities occurred, or historical environment data describing environments at which the prior detected vulnerabilities occurred.

16. The method of claim 15, wherein the software asset is at least one of an application, a library, a framework, an application programming interface, a dataset, or a programming language.

17. The method of claim 14, wherein the vulnerability is at least one of a defect, a weakness, or a misconfiguration in the software asset that, when exploited, is likely to compromise at least one of an integrity, an availability, a confidentiality, or a functionality of the software asset or the communication network.

18. The method of claim 14, wherein the network impact of the vulnerability refers to cascading effects that the vulnerability at the software asset is likely to have across the different elements of the communications network leading to at least one of a disruption, a security breach, or a functional impairment at the different elements in the communications network, wherein the different elements in the communications network are located in at least one of a platform, an environment, or an interconnected system.

19. The method of claim 14, wherein the mitigation action refers to one or more tasks that are implemented to reduce or eliminate a risk of the vulnerability being exploited at the different elements in the communication network, wherein the mitigation action comprises at least one of patching, reconfiguring, isolating, or restricting access to the software asset.

20. The method of claim 14, wherein each of the one or more applications executing at the data model system uses a machine learning model executing at the data model system.
